(19) United States
(12) Patent Application Publication
(10) Pub. No.: US 2007/0268447 A1
(43) Pub. Date: Nov. 22, 2007

(54) Eyeglasses with a music playback function

(75) Inventor: Hui-Nan Lin, Kaohsiung (TW)

Correspondence Address: BACON & THOMAS, PLLC, 625 SLATERS LANE, FOURTH FLOOR, ALEXANDRIA, VA, 22314, US

(73) Assignee: King Sound Enterprise Co., Ltd., Kaohsiung (TW)

(21) Appl. No.: 11/436,665

(22) Filed: May 19, 2006

(51) Int. Cl. G02C 5/00

(52) U.S. Cl. 351/41

(57) ABSTRACT

A pair of eyeglasses with a music playback function includes an eyeglass frame, a right support arm having a containing space, and a left support arm having another containing space. The containing spaces of the right support arm and the left support arm contain a music playback module and a storage module respectively, and the storage module can store a music files, and the music playback module can read a music file from the storage module and covert the music file into music for a playback, so that when a user wears the eyeglasses, the user can listen to the music played by the music playback module.

### FIELD OF THE INVENTION

The present invention relates to eyeglasses, and more particularly to eyeglasses with a music playback function.

### BACKGROUND OF THE INVENTION

As the present world differs from the past and enters into a blooming science and technology era, various different precision electronic products bring us tremendous convenience as well as good quality of life, and these electronic products are indispensable to our life. For example, a music walkman can store a plurality of music files (such MP3 files or sound tracks) and play the music according to user's personal preference, such that users can conveniently listen to music anytime.

The so-called music walkman refers to the early tape walkman, CD walkman, MD walkman, and the present popular MP3 walkman. Manufacturers put up lots of efforts to improve and develop new hardware specifications and software formats and allow extensive consumers to appreciate music better. As the manufacturing technologies of integrated circuits and electronic components advance, various different electronic components usually come with a small size and several circuits of different functions are integrated into a single chip. Such design not only greatly lowers the cost, but also reduces the volume of the walkman. Thus, some manufacturers build a walkman into a necklace and allow users to wear the necklace with a built-in walkman.

However, most structural designs of the walkman are worn at the user's neck or placed in a backpack, before users connect the walkman to an earphone to listen to music. Such arrangement not only causes inconvenience for carrying the devices, but also makes the change of music difficult. Thus, finding a design for a pair of glasses with a music playback function becomes an issue that demands immediate attentions and feasible solutions.

### SUMMARY OF THE INVENTION

In view of the shortcomings of the prior art, the inventor of the present invention based on years of experience to conduct extensive researches and experiments, and finally designed and developed a pair of glasses with a music playback function in accordance with the present invention.

Therefore, it is a primary objective of the present invention to provide a pair of glasses with a music playback function to overcome the shortcomings of the prior art, and the eyeglasses include an eyeglass frame and two support arms, wherein the corresponding two ends of the eyeglass frame are pivotally and separately coupled to the two support arms, so that the two support arms can be movably turned towards the internal side of the eyeglass frame and laid on the internal side of the eyeglass frame to facilitate users to store the eyeglasses. Further, each of the two support arms is comprised of a body, a cover and an ear hanging portion, wherein an end of the body is pivotally coupled to the eyeglass frame and another end is coupled to the ear hanging portion, and the cover is pivotally coupled to the body to create a containing space, such that the two support arms can contain a music playback module or a storage module that stores a music file, and the music playback module can read a music file from the storage module and covert the music file into music for a playback. If a user wears the eyeglasses, the user can listen to the music played from the music playback module.

### BRIEF DESCRIPTION OF THE DRAWINGS

FIG. 1 is a schematic view of an eyeglass frame, a left support arm and a right support arm of the glasses of the invention;

FIG. 2 is a schematic view of a right support arm of the invention;

FIG. 3 is a schematic view of a left support arm of the invention; and

FIG. 4 is a schematic view of a pair of glasses according to a preferred embodiment of the invention.

### DETAILED DESCRIPTION OF THE PREFERRED EMBODIMENTS

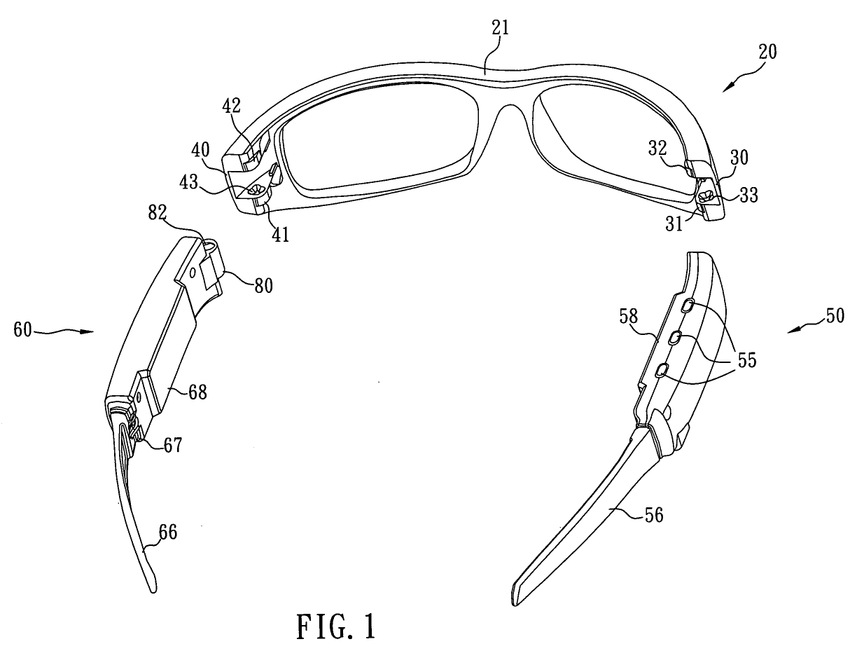

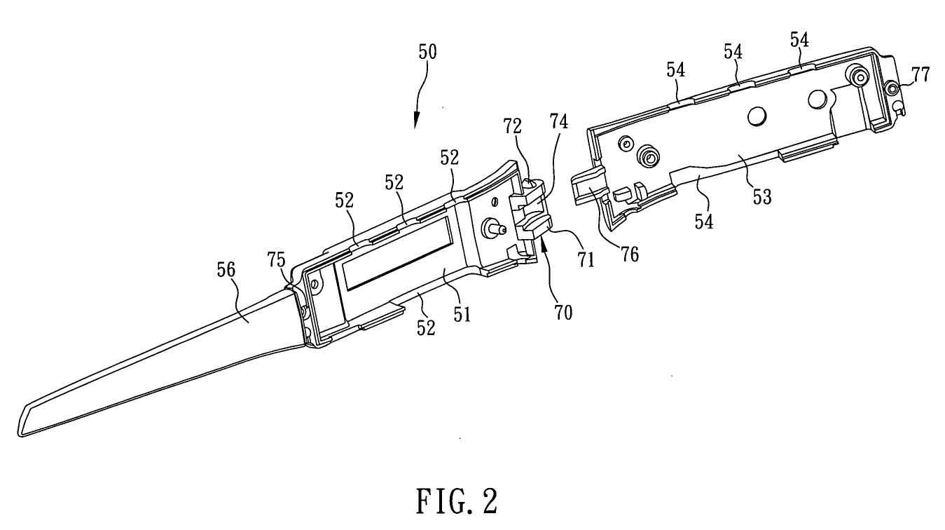

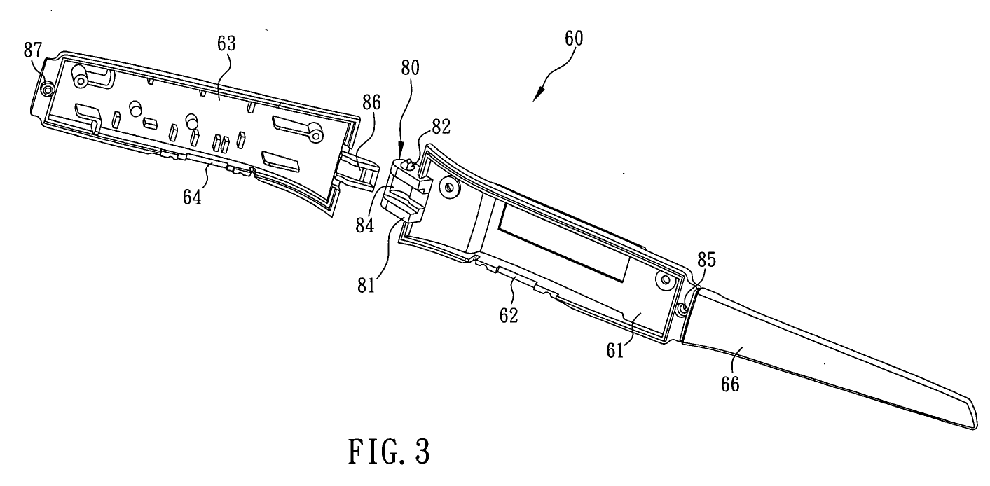

Referring to FIG. 1, the glasses with a music playback function in accordance with the present invention comprises a pair of eyeglasses 20 and the eyeglasses 20 include an eyeglass frame 21, a right support arm 50 and a left support arm 60, wherein the left and right ends of the eyeglass frame 21 separately include a first pivotal connecting portion 30, 40, and the corresponding ends of the right support arm 50 and the left support arm 60 separately include a second pivotal connecting portion 70, 80 (as shown in FIGS. 2 and 3) for pivotally coupling the first pivotal connecting portion 30, 40, and another corresponding ends separately include an ear hanging portion 56, 66 to be hung onto a user's ear conveniently. The right support arm 50 and the left support arm 60 can be movably turned from their second pivotal connecting portions 70, 80 towards the internal side of the eyeglass frame 21, and laid onto the internal side of the eyeglass frame 21 for facilitating users to store and carry the eyeglasses 20.

Referring to FIGS. 2 and 3, the right support arm 50 and the left support arm 60 are separately comprised of a body 51, 61, a cover 53, 63 and an ear hanging portion 56, 66, wherein an end of each body 51, 61 includes the second pivotal connecting portion 70, 80, and another end of each body 51, 61 is coupled to the ear hanging portion 56, 66, and the cover 53, 63 is pivotally coupled to the body 51, 61 and creates a containing space from the body 51, 61 for separately placing a music playback module (not shown in the figure) and a storage module (not shown in the figure) into the containing space of the right support arm 50 or the left support arm 60, so that when a user wears the eyeglasses 20, the user can listen to the music played by the music playback module. The music playback module can read a music file from the storage module and convert the music file into music for the playback. It is noteworthy that the data transmission between the music playback module and the storage module according to the present invention can be accomplished by extending and connecting a plurality of transmission lines into the right support arm 50, the left support arm 60 and the eyeglass frame 21 (as shown in FIG. 1) or by a wireless transmission technology. The present invention intends to claim the structure of the eyeglasses 20, and thus the electronic circuits of the music playback module and the storage module will not be described here.

Referring to FIGS. 2 and 3, the containing space of the right support arm 50 is used for containing the music playback module, and the containing space of the left support arm 60 is used for containing the storage module. Each body 51, 61 includes a plurality of first half holes 52, 62 disposed on at least one edge connecting to the cover 53, 63, and an edge of the cover 53, 63 connecting to the body 51, 61 includes a second half hole 54, 64 disposed at a position corresponding to each first half hole 52, 62, such that after each body 51, 61 is coupled with its cover 53, 63, the first half holes 52, 62 are connected with the corresponding second half holes 54, 64 to form a through hole 55 (as shown in FIG. 1) for fixing a press key (such as a setup key or a play key) or a connecting element (such as an audio terminal and a transmission terminal) of the music playback module and the storage module into the through hole 55 (or protruded from the through hole 55) for users to operate (such as pressing the press key), externally connect the earphone or electrically connect the computer.

Referring to FIGS. 2 and 3 for a preferred embodiment of the present invention, the ear hanging portion 56, 66 of the right support arm 50 and the left support arm 60 is extended linearly to a predetermined length from the corresponding body 51, 61 in a direction away from the eyeglass frame 21, such that the right support arm 50 and the left support arm 60 are substantially in the shape of a linear bar for allowing a user to place the two ear hanging portions 56, 66 onto the user's auricle. Further, each ear hanging portion 56, 66 is substantially in the shape of a plate, and the width of an end connecting to the body 51, 61 is larger than the width of another end without connecting to the body 51, 61 to constitute a tapered structural design. Such design can maintain the strength of connecting the body 51, 61 as well as achieving the effects of reducing the material consumption, lowering the cost, and providing an artistic streamline appearance.

Referring to FIGS. 2 to 4 for the schematic view of another preferred embodiment of the present invention, the lower edges of the right support arm 50 and the left support arm 60 facing the user's ears includes an earphone 90, 91, and the two earphones 90, 91 are protruded outward from the body 51, 61 and the cover 53, 63 and extended downward to a predetermined length to constitute an angle with the corresponding ear hanging portion 56, 66. If a user places the two ear hanging portions 56, 66 on the user's auricle, the two earphones 90, 91 will be placed into the corresponding external auditory meatus to limit the position of the two earphones 90, 91, and the two earphones 90, 91 and the two ear hanging portions 56, 66 are mounted onto the corresponding ears, such that the eyeglasses 20 can be fixed onto the user's body. Further, the two earphones 90, 91 are elastic and capable of coping with the shape and structure of the user's ears by bending the two earphones 90, 91 appropriately.

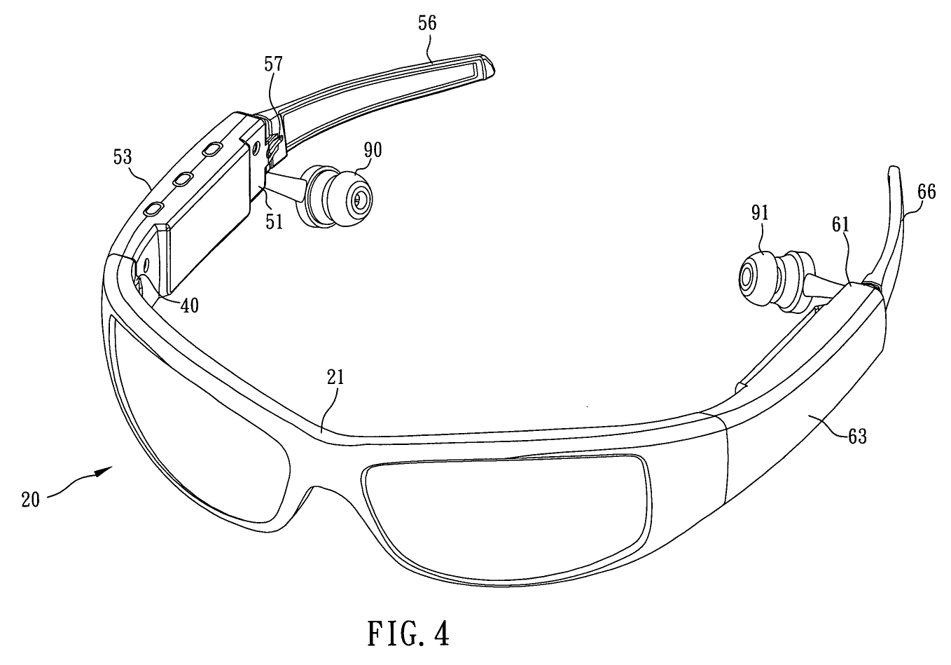

Referring to FIGS. 1 and 4, a support stand 57, 67 is disposed on a corresponding surface of the right support arm 50 and the left support arm 60 of each body 51, 61 and at a position adjacent to its ear hanging portion 56, 66. Each support stand 57, 67 is extended from the body 51, 61 to the ear hanging portion 56, 66 and coupled to the ear hanging portion 56, 66, so that when the ear hanging portion 56, 66 is turned by an external force and bent towards to the internal side of the eyeglass frame 21, the design of extending the support stand 57, 67 from the body 51, 61 to the ear hanging portion 56, 66 bends the ear hanging portion 56, 66 along a distal end opposite to the support stand 57, 67 to limit the angle of each ear hanging portion 56, 66 facing the internal side of the eyeglass frame 21 and prevent the ear hanging portion 56, 66 from breaking at the position connected with the body 51, 61 due to an excessively large bending angle.

Referring to FIGS. 1 and 2, the two first pivotal connecting portions 30, 40 separately include two parallel chunks 31, 32, 41, 42 disposed on both left and right ends of the eyeglass frame 21 and protruded from the upper and lower edges of the eyeglass frame 21 respectively. There is a gap between the two chunks 31, 32, 41, 42 of each first pivotal connecting portion 30, 40 for containing the corresponding second pivotal connecting portion 70, 80. The two chunks 31, 32, 41, 42 of each first pivotal connecting portion 30, 40 includes a concave hole 33, 43 disposed on a corresponding side of the two chunks 31, 32, 41, 42. Referring to FIG. 3, the two second pivotal connecting portions 70, 80 separately include a connecting element 71, 81 disposed at an end of the body 51, 61 facing the eyeglass frame 21, and each connecting element 71, 81 is contained between the two chunks 31, 32, 41, 42 of the corresponding first pivotal connecting portion 30, 40, such that the right support arm 50 and the left support arm 60 are pivotally coupled to the eyeglass frame 21, and the two connecting elements 71, 81 separately include a protruding member 72, 82 disposed on the corresponding side of the two chunks 31, 32, 41, 42, such that when the two connecting elements 71, 81 are contained into the corresponding two chunks 31, 32, 41, 42, the two protruding members 72, 82 of each connecting element 71, 81 are pivotally coupled to the two concave holes 33, 43 of the two corresponding chunks 31, 32, 41, 42, so that the right support arm 50 and the left support arm 60 can be pivotally coupled to the eyeglass frame 21 and turned freely.

Referring to FIGS. 2 and 3 again, the body 51, 61 of each connecting element 71, 81 includes an embedding groove 74, 84 and another embedding groove 75, 85 disposed adjacent to the ear hanging portion 56, 66, and each cover 53, 63 includes an embedding member 76, 86 disposed on a surface of the corresponding body 51, 61 facing an end of the connecting element 71, 81 and another embedding member 77, 87 disposed at the position of another embedding groove 75, 85, such that when each cover 53, 63 is coupled to the corresponding body 51, 61, each embedding member 76, 86 is embedded into the corresponding embedding groove 74, 84 and each other embedding member 77, 87 is embedded into another embedding groove 75, 85, such that each cover 53, 63 is fixed onto the corresponding body 51, 61.

Referring to FIG. 1 again, an attaching portion 58, 68 is disposed separately on the two bodies 51, 61 and at a side facing both of the right support arm 50 and the left support arm 60. The two attaching portions 58, 68 are made of a soft material such as foam or leather, so that when a user wears the eyeglasses 20, the two attaching portions 58, 68 will be attached precisely onto the user's face. Such arrangement can improve the connection of the eyeglasses 20 with the user, and also can provide a comfortable wear and let users wear the glasses for long hours.

What is claimed is:

1. A pair of eyeglasses with a music playback function, comprising:
an eyeglass frame, having a first pivotal connecting portion disposed separately on the right and left ends of said eyeglass frame;
a right support arm and a left support arm, each comprised of a body, a cover and an ear hanging portion, and an end of said body having a second pivotal connecting portion pivotally coupled to said first pivotal connecting portion and another end of said body being coupled with said ear hanging portion, and said cover being coupled to said body and creating a containing space with said body.

2. The eyeglasses of claim 1, wherein said body includes a plurality of first half holes disposed on at least one edge proximate to said cover, and said cover includes a second half hole disposed at an edge of said body and corresponding to the position of said each first half hole, such that when said body and said cover are coupled, said first half holes and said corresponding second half hole are combined to form a through hole.

3. The eyeglasses of claim 2, wherein said each ear hanging portion is extended linearly from said eyeglass frame to a predetermined length along the direction away from said body, so that said right support arm and said left support arm are substantially in a linear bar shape.

4. The eyeglasses of claim 3, wherein said each ear hanging portion is in the shape of a plate, and the width of said ear hanging portion at an end connecting to said body is larger than another end without connecting to said body.

5. The eyeglasses of claim 4, wherein said right support arm and said left support arm at their lower edge separately include a flexible bent earphone, and said two earphones are protruded outward from said body and said cover and extended downward to a predetermined length to produce an angle between their corresponding ear hanging portions.

6. The eyeglasses of claim 5, wherein said two bodies separately include a support stand disposed at the corresponding surfaces of said two bodies and proximate to the position of said ear hanging portion, and said each support stand is extended from said body to said ear hanging portion and coupled to said ear hanging portion.

7. The eyeglasses of claim 6, wherein said each first pivotal connecting portion is comprised of two chunks, and said two chunks of said each first pivotal connecting portion are protruded respectively from the left and right ends of said eyeglass frame and maintained with an interval apart for containing said corresponding second pivotal connecting portion, and a corresponding surface of said each chunk includes a concave hole; said second pivotal connecting portion comprises a connecting element disposed at an end of said body facing said eyeglass frame, and a protruding member disposed at a position facing said two chunks of said corresponding first pivotal connecting portion and pivotally coupled to a protruding member corresponding to said concave hole.

8. The eyeglasses of claim 7, wherein said connecting element of said each body includes an embedding groove, and another embedding groove disposed at a position adjacent to said ear hanging portion, and an embedding member is disposed on a surface of said cover facing said body and at an end of said cover facing said connecting element and embedded into said embedding groove, and another embedding member is disposed at a position facing said other embedding groove and embedded into said other embedding groove.

9. The eyeglasses of claim 8, further comprising an attaching portion disposed on a mutually facing surface of said right support arm and said left support arm.
